(19) United States
(12) Patent Application Publication
(10) Pub. No.: US 2004/0179266 A1
(43) Pub. Date: Sep. 16, 2004

(54) Diffractive security element

(76) Inventors: Andreas Schilling, Hagendorn (CH); Wayne Robert Tompkin, Baden (CH)

Correspondence Address: Charles R Hoffmann, Hoffman & Baron, 6900 Jericho Turnpike, Syosset, NY, 11791, US

(21) Appl. No.: 10/477,163

(22) PCT Filed: May 31, 2002
(86) PCT No.: PCT/EP02/05987

(30) Foreign Application Priority Data
Jun. 8, 2001 (DE) 101 27 980.9

(51) Int. Cl. G02B 5/18; G02B 27/42

(52) U.S. Cl. 359/558

(57) ABSTRACT

A security element which is stuck on to a substrate has a reflecting, optically variable surface pattern (11) which is embedded in a layer composite of plastic material and which is visually recognisable to the naked eye from predetermined observation directions. The surface pattern (11) is formed from a mosaic of surface elements (12; 13; 14) with optically active structures. At least in a part of the surface pattern (11) identical surface portions (15) with optically active relief structures are additionally arranged regularly in regions which are independent of the mosaic. The surface portions (15) involve a largest dimension of less than 0.2 mm and a length-to-width ratio of at least 3:1, wherein the center points (16) of the surface portions form a dot matrix with periods of more than 8 dots per mm and the longitudinal surface portions (15) in each region are oriented parallel to a preferred direction. The regions form an item of concealed, visually imperceptible information which appears as an artefact on a color copy of the security element and can be recognised by the naked eye.

The invention relates to a diffractive security element as set forth in the classifying portion of claim 1.

Such diffractive security elements are used for verifying the authenticity of a document and are distinguished by an optically variable pattern which changes in a striking and predetermined manner from the point of view of the person observing it by virtue of rotation or tilting movement.

Diffractive security elements of that known from many sources, reference is made here as representative examples to EP 0 105 099 B1, EP 0 330 738 B1 and EP 0 375 833 B1. They are distinguished by the brilliance of the patterns and the movement effect in the pattern, they are embedded in a thin laminate of plastic material and they are glued in the form of a stamp on to documents such as banknotes, bonds, personal identity papers, passports, visas, identity cards and so forth. Materials which can be used for production of the security elements are summarised in EP 0 201 323 B1.

Modern photocopiers and scanner devices are capable of duplicating such a document in apparently true colors. The diffractive security elements are also copied, in which case admittedly the brilliance and the movement effect are lost so that the pattern which is visible in the original at a single predetermined angle of view is reproduced as an image with the printing colors of a color photocopier. Such copies of documents can be easily confused with the original under poor lighting conditions or if the observer is not paying attention. The known security elements suffer from the disadvantage that the man in the street cannot easily recognise the copies as being such.

It is known from EP 0 490 457 B1 that it is possible to dispose in a visually recognisable image a second, visually unrecognisable image comprising fine line portions. The content of the second image is coded in the slope of the line portions with respect to the line portions of the background. In the copying operation the second image appears over the first image with a blackening effect which is dependent on the slope angles of the line portions. Therefore the second image is dependent on the position of the original on the copier machine. Theoretical considerations in that respect are set forth in ‘Optical Document Security’, van Renesse, Editor, ISDN No 0-89006-982-4, pages 127-148.

The object of the present invention is to provide a visually recognisable, inexpensive diffractive security element having an optically variable surface pattern which, in a copy produced by a color photocopier, has second concealed information which is independent of the surface pattern.

In accordance with the invention the specified object is attained by the features recited in the characterising portion of claim 1. Advantageous configurations of the invention are set forth in the appendant claims.

Embodiments of the invention are described in greater detail hereinafter and illustrated in the drawing in which:

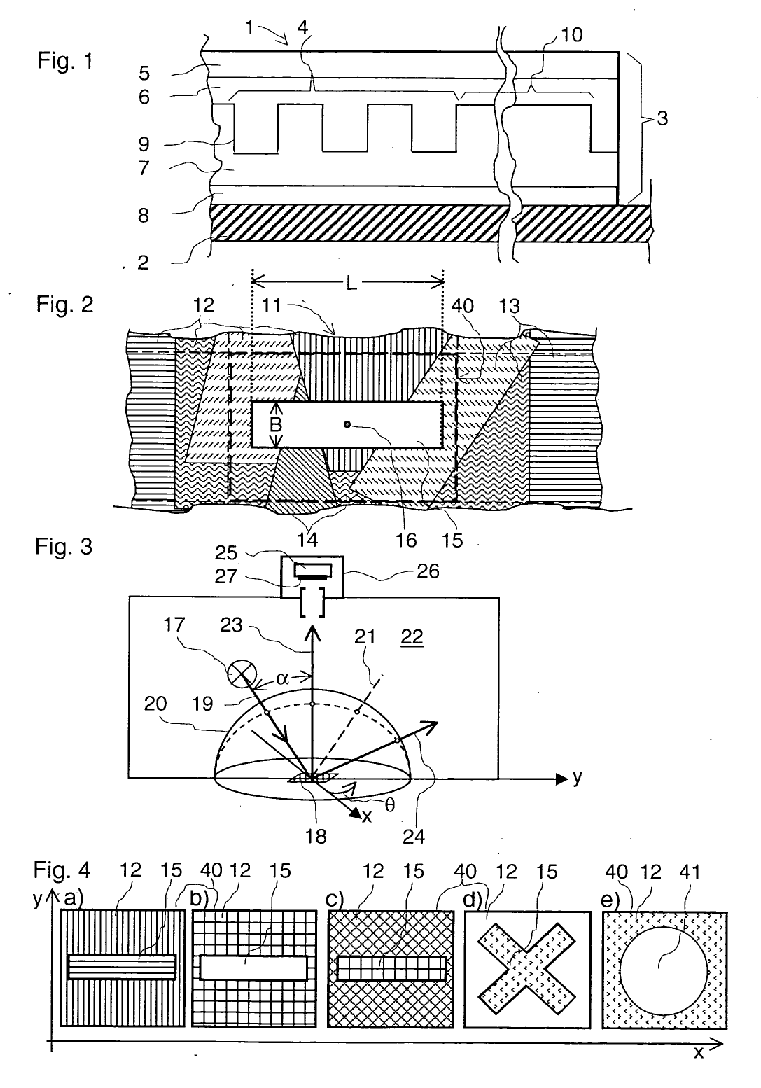

FIG. 1 is a view in cross-section through an optically variable security element,

FIG. 2 shows a portion from a surface pattern,

FIG. 3 shows a view in cross-section through an optical scanning apparatus,

FIG. 4 shows unit cells,

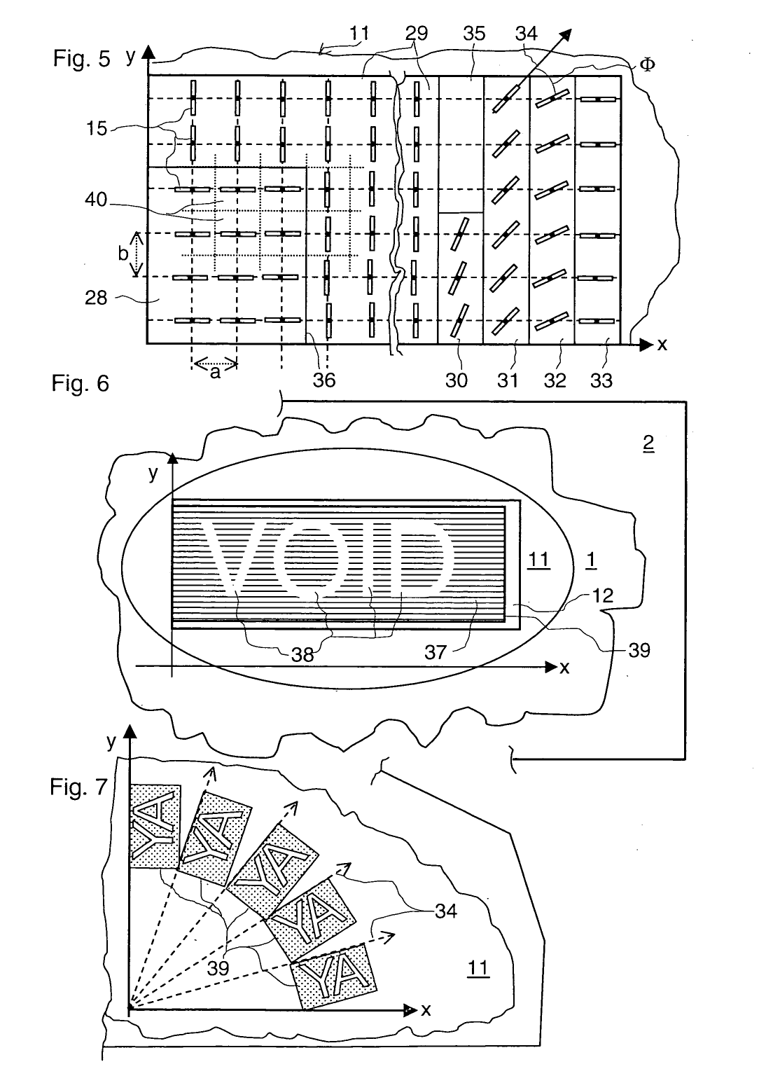

FIG. 5 shows regions of the surface pattern,

FIG. 6 shows a copy of a panel in the surface pattern,

FIG. 7 shows a portion of a copy of the security element, and

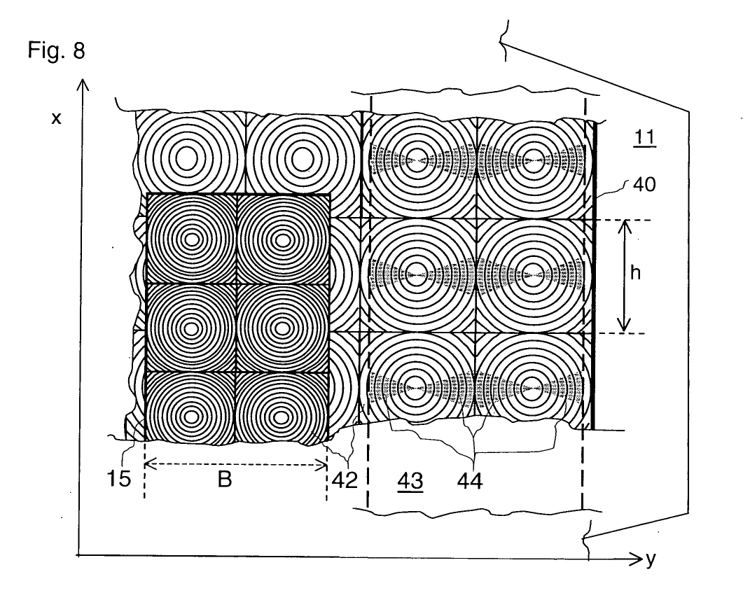

FIG. 8 shows a unit cell with circular diffraction gratings.

In FIG. 1, reference 1 denotes an optically variable security element, reference 2 denotes a substrate, reference 3 a layer composite, reference 4 a microscopically fine structure, reference 5 a cover layer, reference 6 a lacquer layer, reference 7 a protective lacquer layer, reference 8 an adhesive layer, reference 9 an interface layer and reference 10 a mirror surface. In the illustrated cross-section through a document the layer composite 3 of the security element 1 is joined to the substrate 2 by means of the adhesive layer 8. The term documents is used to denote in particular passes, banknotes, visas, bonds, entry cards and so forth which serve as a substrate 2 for the security element 1 and the authenticity of which is verified by the security element 1 stuck thereon. The microscopically fine, mechanically or holographically produced, optically active structures 4 are embedded in a layer composite 3 of plastic material. For example the layer composite 3 comprises, in the specified sequence, the transparent cover layer 5 which is as clear as glass. Arranged under the cover layer 5 is a transparent lacquer layer 6 in which the microscopically fine, optically active structure 4 is formed. The structure 4 is covered with a protective lacquer layer 7 in such a way that the grooves of the active structure 4 are filled by the protective lacquer layer 7 and the active structure 4 is embedded between the lacquer layer 6 and the protective lacquer layer 7. An adhesive layer 8 is disposed between the substrate 2 and the protective lacquer layer 7 in order to fixedly connect the layer composite 3 to the substrate 2. The layers 5 and 6, and 7 and 8 respectively can be of the same respective material in other embodiments so that there is no interface between the layers 5 and 6, and 7 and 8 respectively. The active structure 4 defines an interface 9 between the layers 6 and 7. The optical effectiveness of the interface 9 increases with the difference in the refractive indices of the materials in the two adjoining layers, the lacquer layer 6 and the protective lacquer layer 7. To increase the optical effectiveness of the interface 9 the optically active structure 4, prior to application of the protective lacquer layer 7, is covered with a metallic or dielectric reflection layer which is thin in comparison with the depths of the grooves. Other embodiments of the layer composite 3 and the materials which can be used for transparent or non-transparent security elements 9 are described in EP 0 201 323 B1 to which reference is made in the opening part of this specification. The structure 4 shown in FIG. 1 is only symbolically illustrated in the form of a simple rectangular structure and stands for general, optically active structures 4 such as light-diffractive relief structures, light-scattering relief structures or mirror surfaces 10 (FIG. 1). Known light-diffractive relief structures are linear or circular diffraction gratings and holograms. The light-scattering relief structures are for example matt structures.

FIG. 2 shows a portion of a security element 1 (FIG. 1). Through the cover layer 5 (FIG. 1) an observer viewing it, from predetermined observation angles, visually recognises the effect of the optically active structure 4 (FIG. 1) of a surface pattern 11. The surface pattern 11 is a mosaic of many surface elements 12, 13, 14, in which the optically active structures 4 are formed. From the point of view of the observer, only the respective surface elements 12, 13, 14 which have an optical-diffraction effect and which deflect light incident on to their optically active structures 4 into the eye of the observer are visible. Other surface elements 12, 13, 14 become visible by virtue of rotation or tilting of the security element 1 about one of its three axes, and alter the image which can be recognised by virtue of the optical effect of the surface pattern 11.

Independently of the surface elements 12, 13, 14, a plurality of surface portions 15 each having a respective center point 16 are regularly arranged in the optically active structures 4 in at least a part of the surface pattern 11 in such a way that the center points 16 form a dot matrix. Other optically active structures 4 are formed in the surface portions 15. The organisation of the surface elements 12, 13, 14 is only shown by way of example in the drawing in FIG. 2 and only illustrates the independence of the surface portion 15 from the surface pattern 11. In actual fact the surface elements 12 through 14 are mostly much larger than the surface portions 15. The surface portions 15 are identical and are of an elongate shape, wherein the ratio of length L to width B is at least three, that is to say L/B≧3. The largest dimension, that is to say the length L, is smaller than 0.2 mm, for example 0.170 mm. This means that the dimensions are so small that the surface portion 15 in the surface pattern 11 can just no longer be recognised by the naked eye at a viewing distance of 30 cm, that is to say, the observer, upon rotation and tilting, only recognises a background with the images of the surface pattern 11, which are dependent on the observation direction and which are produced by the surface elements 12 through 14.

In the copying operation with a digital color photocopier only the surface portions 15 which are oriented transversely to the scanning direction of the color photocopier are registered. If the surface portions 15 are arranged regularly on the surface pattern 11 a unit cell 40 of a dot matrix of rectangular—or hexagonal—shape can be associated with each surface portion 15, wherein the center point 16 coincides with the diagonal intersection of the unit cell 40. The unit cell 40 is shown in broken lines in FIG. 2 as that organisation is only illustrated for the purposes of better understanding. A surface proportion of the unit cell 40, which proportion is not occupied by the surface portion 15, contains a proportion of the surface pattern 11, for example of the surface element 12. Each unit cell 40 is a pixel of an item of concealed information which is not visible with the naked eye in the original surface pattern 11 but which is clearly visible in a color copy.

An advantage of the present invention is the high reproducibility of the arrangement of the surface portions 15 in the surface element 11 by shaping of the optically active structures 4 in a working operation in the lacquer layer 6 (FIG. 1). In the security element 1 the surface portions 15 are arranged under the cover layer 5 and therefore protected from mechanical and/or chemical attack.

FIG. 3 is a diagrammatic view in cross-section through a digital optical scanning apparatus (=scanner) of a color photocopier. A surface 18 which is illuminated by means of a white light source 17 in a narrow strip is in a plane defined by co-ordinate directions x and y. The surface 18 is part of the surface pattern 11 (FIG. 2) or the surface portion 15 (FIG. 2). At least a part of the light beam 19 which is incident on the surface 18 is reflected back into a half-space 20 above the illuminated surface 18. If the surface 18 is a mirror surface then the incident light is returned primarily in accordance with the laws of reflection in the form of a reflection beam 21. The direction of the incident light beam 19 and the reflection beam 21 define a diffraction plane 22. The diffraction plane 22 intersects the half-space 20 which is shown in the form of a hemisphere in a large circle shown in broken line and is perpendicular to the surface 18. The surface 18 is covered by a diffraction grating whose grating vector (not shown here) is in the diffraction plane 22 and is oriented relative to the co-ordinate direction y, that is to say relative to the scanning direction, wherein the grating vector has an azimuth θ of 90° or 270° respectively as measured with respect to the co-ordinate direction x. The light diffracted at the diffraction grating is split up into spectral colors and diverted in the diffraction plane 22 in directions 23, 24 which are symmetrical with respect to the reflection beam 21. The spatial frequency f and the wavelength λ of the diffracted light determine the diffraction angle between the reflection beam 21 and the directions 23 and 24 respectively. In the illustrated example the direction 23 is perpendicular to the surface 18. The parameters of the diffraction grating are to be so selected that the light beam 19 is diffracted for a predetermined spectral color in the direction 23, of the normal to the surface 18, and registered by a light receiver 26. If the grating vector deviates from the azimuth θ=90° or 270° respectively and/or the diffracted light does not pass into the light receiver 26, then the surface 18 is reproduced in a dark gray color because of the light which is scattered at the optically active structure 4 (FIG. 1). If the diffraction grating has a very high line density (>2,500 lines/mm), its first order can no longer be emitted into the half-space 20, but the diffraction grating behaves like a colored mirror and is registered as black in the color photocopier as no light is incident in the light receiver 26. If the surface 18 has a matt structure the incident white light 19 is scattered without being spectrally split up into the entire half-space 20 and is registered by the color photocopier according to the intensity thereof as white or gray. In contrast to an isotropic matt structure an anisotropic matt structure preferably deflects the incident light 19 into a predetermined spatial angle region. The anisotropic matt structure permits the reproduction of gray values. If the surface 18 absorbs the incident light 19 no light is sent back into the half-space 20. The angle of incidence of the light beams 19 on the surface 18 involves a value in the range of between 25° and 30° and is typical for the manufacturer of the color photocopier.

Modern color photocopiers with digital scanning, referred to hereinafter as color photocopiers, have a resolution of at least 12 dots/mm (=300 dpi) in each of the Cartesian co-ordinate directions x and y. The white light source 17 emits the light beams 19 in parallel relationship with the illustrated diffraction plane 22 obliquely on to the surface 18 and illuminates the surface 18 in the narrow strip which is oriented along the co-ordinate direction x. All light which is returned in the direction 23 passes into one of a plurality of photodetectors 25 of the light receiver 26. The light receiver 26 is diagrammatically shown in section in FIG. 3. In the co-ordinate direction x the illuminated narrow strip and the light receiver 26 extend over the entire width of a support for the substrates 2 to be copies (FIG. 1), for example an A4 or A3 sheet. At least twelve photodetectors 25 per millimeter are arranged for each of the three primary colors. For the digital scanning operation the white light source 17 and the light receiver 26 move stepwise in the co-ordinate direction y. In each step an image, which is registered in the light receiver 26 on photosensitive surfaces 27 of the photodetectors 25, of the narrow strip illuminated on the surface 18 is scanned dot-wise by the photodetectors 25. In the operation of reading out the image intensity values in respect of the light beams 19 deflected in the direction 23 are registered by the photodetectors 25.

As a consequence of the finite resolution in the light receiver 26, the registered signal depends on the orientation of the surface portions 15 relative to the scanning direction in the color photocopier. A possible configuration of the color photocopier suppresses the signal of an individual photodetector 25 if adjacent photodetectors register very greatly differing intensity values, insofar as the differing signal is adjusted to the adjacent values. That suppresses interference signals. That procedure is performed for each primary color independently of the other two. Similar intensity comparison operations in the co-ordinate direction y are not effected. The width B of the surface portion 15 (FIG. 2) determines the level of color photocopier resolution, up to which the protective effect described hereinafter is operative. If for example the width B=0.04 mm or 0.02 mm, then the protective effect is given in the case of the color photocopier with a degree of resolution of up to 24 dots/mm (=600 dpi) and 48 dots/mm (=1200 dpi) respectively, as a signal in respect of the surface portion 15 upon scanning transversely with respect to the longitudinal extent is suppressed because only one individual photodetector 25 produces a signal for the surface portion 15. If in contrast the surface portion 15 is oriented with its longitudinal extent parallel to the co-ordinate direction x the photocopier detects the surface portion 15 as, even with a low level of resolution of 12 dots/mm, at least two mutually juxtaposed photodetectors 25 register the signal of the surface portion 15.

FIGS. 4a through 4e diagrammatically show unit cells 40 with a respective surface portion 15 arranged therein. The surface proportion of the unit cell 40, which is not occupied by the surface portion 15, is a part of the surface elements 12 through 14 (FIG. 2). The surface proportion of the surface portion 15 in relation to the unit cell 40 is preferably less than 20 percent as otherwise the surface brightness of the surface element 12 is markedly attenuated. By way of example set out hereinafter are five combinations of the above-mentioned optically active structures with which the surface elements 12 and the surface portions 15 can be provided.

In Example a the grooves of the diffraction grating of the surface element 12 and the grooves of the diffraction grating of the surface portions 15 are oriented in mutually perpendicular relationship, wherein the orientation of the grooves in the surface portion 15 is always parallel to the co-ordinate direction x, independently of the orientation of the surface portion 15 in the unit cell 40. If (in an example 4a.1 which is not shown) the grooves of the diffraction grating in the surface element 12 were parallel to the grooves in the surface portion 15, the diffraction gratings would differ by virtue of their spatial frequency f.

In Example b the surface portion 15 is occupied by a mirror surface 10 (FIG. 1) while the surface element 12 has a cross grating, as the optically active structure (FIG. 1). The cross grating is defined by two spatial frequencies f1 and f2, wherein the spatial frequencies f1 and f2 are equal in specific examples.

In Example c the cross gratings in the surface portions 15 and in the surface element 12 are rotated relative to each other at the azimuth through 45°. So that the diffracted light is deflected into the direction 23 (FIG. 3) of the normal to the surface 18 (FIG. 3), that is to say with respect to the surface element 12 or the surface portion 15, the spatial frequencies f in accordance with the equation:

sin(δ=0°)−sin(α)=k·λ·f

must be selected, for the light-diffracting relief structures, wherein a is the angle of incidence of the light beams 19 (FIG. 3), δ=0° is the diffraction angle of the light diffracted into the direction 23 (FIG. 3) normal to the surface 18 (FIG. 3), of the wavelength λ and k is the diffraction order. For an angle of incidence a of between 25° and 30° and with k=1 the range of the spatial frequencies f is between 725 lines/mm and 1025 lines/mm; with k=2 the usable spatial frequencies f are between 350 lines/mm and 550 lines/mm so that the diffracted light passes into the light receiver 26 (FIG. 3). The range limits are predetermined by the color sensitivity of the light receiver 26. In order to compensate for possible unevenness of the surface pattern 11 it is advantageous to modulate the spatial frequency f, in which case the spatial frequency f desirably changes periodically over a period of between 0.2 mm and 0.6 mm with a variation of 5 lines.

Examples 4d and 4e are less critical in terms of the illumination conditions in the color photocopier.

In Example 4d the surface element 12 is a mirror surface and the surface portion 15 involves a matt structure.

In Example 4e a circular surface 41 is occupied by a mirror surface and the surface element 12 by a matt structure.

The surface portions 15 in the elongate shape are sensitive in regard to the scanning direction as, because of the small width b of the surface portions 15, the effective length of the surface portions 15 can be too short with just a deviation of the scanning direction of a few degrees of angle from the ideal direction.

For special effects, the surface portion 15 can be of a cross shape as in FIG. 4d or it can be replaced by a circular surface 41 (FIG. 4e). The color photocopier registers the cross shape in a scanning operation parallel to the two arms of the cross, for example at 45° and 135° to the coordinate direction x, while the circular surface 41 is registered irrespective of the orientation of the surface pattern 11 (FIG. 2). As a different appearance is to be produced in dependence on the scanning direction, it will be appreciated that not all unit cells 40 may be provided with cross-shaped (FIG. 4d) or circular (FIG. 4e) surface portions 15.

If at least a certain dependency of the image which is produced in the scanning operation on the scanning direction is wanted, then instead of the circular surface portions 41 as shown in FIG. 4e it would be necessary to provide for example elliptical surface portions which then involve a corresponding asymmetry in order in that way to provide that the surface portions 41 are visible upon scanning in a predetermined direction but are not visible in another direction. In a corresponding manner, in regard to the cross-shaped surface portions 15 in FIG. 4d, it would also be possible to achieve an asymmetry for example by using distorted crosses or crosses whose bars do not intersect substantially perpendicularly.

FIG. 5 shows a portion of the surface pattern 11 in the first quadrant of a co-ordinate system x/y. Independently of the mosaic of the surface elements 12 (FIG. 2), 13 (FIG. 2), 14 (FIG. 2), a part of the surface pattern 11 is divided into regions 28 through 33. The regions 28 through 33 are subdivided into the mutually abutting unit cells 40 so that the center points 16 (FIG. 2) of the surface portions 15 form a regular dot matrix with the periods a and b in the co-ordinate directions x and y. In another embodiment the periods are equal, that is to say a=b, wherein the length of the periods a, b reaches at least the length L of the surface portions 15 or exceeds same. However, at any event the dot matrix has a level of resolution of at least 8 dots per millimeter. In each of the regions 28 through 33 the surface portions 15 involve an orientation parallel to a preferred direction 34. If the regions 28 through 33 are not separated by free areas 35, each of the regions 28 through 33 differs from the adjoining regions 28 through 33 by virtue of its preferred direction 34. In the first region 28 a directional angle measured between the preferred direction 34 and the co-ordinate direction x is Φ=0°. In the adjoining second region 29 the directional angle is Φ=90°. The free areas 35 arranged within the regions 28 through 33 do not contain any surface portions 15. The division of the surface pattern 11 into the regions 28 through 33 and into the regions 28 through 33 and the free areas 35 respectively is determined by the concealed information.

The drawing in FIG. 5 shows some of the unit cells 40 with a boundary consisting of a dotted line. So that the naked eye does not perceive the arrangement of the surface portions 15, the periods are so small that at least 8 unit cells 40 fit on to a millimeter. In another embodiment the surface portions 15 involve a smaller spacing in at least one of the regions 28 through 33 perpendicularly to the preferred direction 34, wherein a and b respectively is less than the length of the surface portions 15.

As mentioned above the light receiver 26 (FIG. 3) is subdivided into a finite number of photodetectors 25 (FIG. 3). Transversely with respect to the scanning direction the image of the surface 18 (FIG. 3), which is detected by the photodetectors 25, is resolved into individual pixels. If the surface portions 15 are aligned in substantially parallel relationship with the scanning direction, they are not registered because of their small transverse dimension, the width B. In contrast, if the surface portions 15 are aligned in substantially perpendicular relationship to the scanning direction, the light receivers 26 detect the surface portions 15. Depending on the respective design configuration of the color photocopier, a dotted line or a solid line which is an artefact of the color photocopier appears in the copy, instead of an image of the aligned surface portions 15.

By way of example the surface pattern 11 is so oriented that the scanning direction coincides with the co-ordinate direction y. In the first region 28 the surface portions 15 are oriented perpendicularly to the scanning direction, that is to say parallel to the co-ordinate direction x. In the color copy of the security element 1 (FIG. 1) which is scanned in the co-ordinate direction y, in addition to the image of the color pattern 11 there are lines or line portions which connect the surface portions 15 and which the observer recognises in the color copy in the form of fine hatching parallel to the co-ordinate direction x of the first region 28. In the second region 29 the preferred direction 34 of the surface portions 15 is parallel to the scanning direction so that the color photocopier does not register the surface portions 15. In the color copy, besides the image of the surface pattern 11, it is not possible to recognise the surface portions 15, nor is the second region 29 hatched. At the normal viewing distance the hatching in the first region 28 produces a gray or color contrast in relation to the reproduction of the second region 29. If in contrast the scanning of the security element 1 takes place in the co-ordinate direction x the second region 29 in the copy is hatched parallel to the co-ordinate direction y and the first region 28 is not hatched. Boundary lines 36 between the regions 28 through 33 and the free area 35 are only shown in FIG. 5 for reasons relating to the drawing. In the color copy, the free areas 35 are never hatched, irrespective of the scanning direction.

As shown on the right-hand side in FIG. 5 the regions 29 and 33 with the directional angles Φ=90° and 0° are separated by at least one further region 30 through 32 so that the directional angle Φ changes in intermediate steps in the further regions 30 through 32. That arrangement has the advantage that, with any orientation of the original, the concealed information is visible in the copy as at least one of the regions is oriented almost parallel to the illuminated strip on the surface 18 (FIG. 3) and the hatching appears in the copy. So that the concealed information which is only visible in the copy is conspicuous, the regions 28 through 33 and the possible free areas 35 involve minimum dimensions of at least two unit cells 40. Instead of the intermediate stages it is also possible to use unit cells 40 with cross-shaped surface portions 15 (FIG. 4d) or with circular surfaces 41 (FIG. 4e).

In FIG. 6 an embodiment of the security element 1, within the surface pattern 11, has a background region 37 and character regions 38. The background region 37 is for example in the form of a panel 39 on which the character regions 38 form the concealed information. In the background region 37 the surface portions 15 (FIG. 1) are arranged in parallel relationship with the co-ordinate direction x so that in the color copy the background surface 37 is hatched. In the character regions 38 the surface portions 15 are rotated through 90° so that no hatching appears there in the copy. The character regions 38 stand out in the photocopy by virtue of their unhatched surface from the background region 37 in such a way that the concealed information is clearly visible to the naked eye.

In a first embodiment the optically active structure 4 (FIG. 1) in the surface element 12 is a diffraction grating. The surface portions 15 have the mirror surfaces 10 (FIG. 1) as the optically active structures 4. As the background the color copy has the pattern which is registered by the color photocopier and which is dependent on the orientation of an original, that is to say the substrate 2 with the surface pattern 11 of the security element 1. When the original is scanned substantially perpendicularly to the preferred direction 34 (FIG. 5), the black hatchings additionally appear in the background region 37 and the character regions 38 stand out from the background region 37 by virtue of the absence of the hatchings. In the illustrated example the character regions 38 form the information ‘VOID’. If the original is turned through 90°, the original is scanned substantially parallel to the preferred direction 34 (FIG. 5) in the background region 37 so that the surface portions 15, in the character regions 38, are detected. In the color copy the information is visible by virtue of the black-hatched character regions 38. The surface element 12 provides a colored background if the azimuth θ (FIG. 3) of the diffraction grating is parallel to the scanning direction. In other orientations the background is dark gray because of the light beams 19 (FIG. 3) scattered at the light-diffracting relief structure. The expression ‘substantially perpendicular or parallel to the preferred direction 34 or the scanning direction respectively’ indicates that, in dependence on the width B of the surface portion 15, the spatial frequency f and the azimuth, approximately ±10° deviation relative to the specified direction is tolerated by the color photocopier.

In other embodiments the background region 37 and the character regions 38 of the panel 39 are made up from unit cells 40 (FIG. 5) of one of the types shown in FIGS. 4a through 4e. In the background region 37 the directional angle Φ=0° (FIG. 5), as is shown in the drawing in FIGS. 4a-c, Φ=45° in the intermediate region 31 (FIG. 5) and Φ=90° in the character region 38. Reproduction of the unit cells 40 with the simple linear diffraction gratings in the color copy in dependence on the scanning direction of the color photocopier is shown in a simplified form in Table 1. The scanning direction is specified in degrees of angle with respect to the co-ordinate direction y. To establish the optical effect it is assumed that, in the scanning direction 0°, the grooves of the diffraction gratings in all surface portions 15 of the panel 39 are oriented in parallel relationship with the preferred direction 34 of the background region 37. The optical effects of the intermediate regions 31 are also described by way of example. In case 4a.1, with the scanning direction of 900, the scatter light registered by the color photocopier from the surface element 12 and the surface portions 15 is of a practically equal intensity so that the concealed information is only visible in the scanning direction 0° in the copy.

In Table 1 colored means a color which is predetermined by the spatial frequency f. In Example 4a.1 the colors of the background region 37 and the surface portions 15 must additionally contrast.

TABLE 1
Reproduction of the unit cells 40 in the color copy

| | | | Hatching | | |
|---|---|---|---|---|---|
| | | Surface | | Inter- | |
| | Scanning | element | Background | mediate | Character |
| Example | direction | 12 | region 37 | region 31 | region 38 |
| | 0° | dark gray | colored | none | none |
| | 45° | dark gray | none | dark gray | none |
| | 90° | colored | none | none | dark gray |
| FIG. 4a.1 | 0° | 1st color | 2nd color | none | none |
| | 45° | dark gray | none | dark gray | none |
| | 90° | dark gray | none | none | dark gray |
| | 0° | colored | black | none | none |
| | 45° | dark gray | none | black | none |
| | 90° | colored | none | none | black |
| | 0° | dark gray | colored | none | none |
| | 45° | colored | none | colored | none |
| | 90° | dark gray | none | none | colored |
| | 135° | colored | none | none | none |
| | 0° | black | white | none | none |
| | 45° | black | none | white | non |
| | 90° | black | none | none | white |
| | 135° | black | none | white | none |
| | 0° | white | black | none | none |
| | 45° | white | none | black | none |
| | 90° | white | none | none | black |

It is also possible to use combinations other than those shown in FIGS. 4a through 4e, of the optically active structures in the surface elements 12 through 14 (FIG. 2) and the surface portions 15; the only important point is that in the color copy the hatching can be seen against the background of the surface elements 12 through 14 (FIG. 2).

In FIG. 7, a plurality of the panels 39 is arranged on the surface pattern 11 in such a way that, in any orientation of the security element 1 in the color photocopier at least one of the panels 39 with the concealed information is legibly reproduced in the copying operation. In this embodiment the preferred directions 34 of the surface portions 15 (FIG. 2), which are shown in dotted lines in FIG. 7, in each of the background regions 37 (FIG. 6), face radially away from a common point. The unit cells 40 of each panel 39 are aligned with the associated preferred direction 34.

FIG. 8, in a portion of the arrangement, shows one of the unit cells 40 and a part of its surface portion 15, in another embodiment of the security element 1. The surface portions 15 and/or the surface elements 12 through 14 (FIG. 2) of the regions 28 through 33 (FIG. 5), 37 and 38 (FIG. 6) are occupied by a circular light-diffracting relief structure. The unit cells 40 and/or the surface portions 15 are divided into surface squares 42. Each surface square 42 has a circular diffraction grating which is centered into the surface quadrant 42 and whose circular grooves are arranged concentrically and are occupied at a predetermined spatial frequency f, wherein corners of the surface squares 42 are filled with corresponding circular segments of the grooves. The spatial frequency f of the unit cells 40 and that of the surface portions 15 differ so that there is a color contrast in the color copy between the hatchings and the background. The surface squares 42 are of a side length h of a value of between 20 μm and 100 μm. The surface portions 15 are of a small width B so that the side length h in the surface portions 15 is advantageously at the lower end of the above-specified range for h and for the unit cell 40 rather than at the upper end of the range for h. However the surface squares 42 of the unit cells 40 and the surface portions 15 may be of the same size, in which case the width B of the surface portions 15 is advantageously selected as the dimension for the side length h. A surface region 43 shown in broken line in FIG. 8 is illuminated with the light beams 19 (FIG. 3). For the scanning operation the surface region moves stepwise in the co-ordinate direction y over the surface pattern 11.

Irrespective of the orientation of the illuminated surface 43 the incident light beams 19 are always diffracted in segments 44 of the circular diffraction grating in the direction of the light receiver 26 (FIG. 3) if the spatial frequency f of the diffraction grating is in the above-described ranges. The segment 44 is delimited radially by two grating vectors which are radii of the circular diffraction grating in the surface square 42. As the diffraction plane 22 (FIG. 3) is parallel to the scanning direction, the effective groove spacing increases with an increasing angle between the grating vector and the diffraction plane 22 so that the color of the diffracted light from the segments is not uniform and color fringes occur towards the radial boundary of the segments 44. In the copy the segments 44 and the other surface proportions of the illuminated surface squares 42 are not resolved. Reproduction of the diffracted light occurs in a mixed color, the main component of which is based on the wavelength λ which is established by the spatial frequency f.

Instead of the circular diffraction gratings with equidistant grooves, it is also possible in other embodiments to use relief structures of Fresnel lenses as the optically active structure 4 (FIG. 1). The focusing properties thereof are optimised in such a way that as much white light as possible is reflected into the light receiver 26 (FIG. 3).

The use of such circular diffraction gratings for the unit cells 40 and/or the surface portions 15 or the circular surfaces 41 (FIG. 4e) has the advantage that in the copy the background of the panel 39, independently of the scanning direction and with suitable orientation the hatchings produced by the surface portions 15 always appear in the mixed color.

In further configurations of the security element 1 mirror surfaces or matt structures occupy the surface of the surface portions 15, instead of the circular diffraction gratings.

1. A security element (1) comprising a reflecting, optically variable surface pattern (11) which is embedded in a layer composite (3) of plastic material and which can be visually recognised from predetermined observation directions, formed from a mosaic of surface elements (12; 13; 14) with optically active structures,
characterised in that
at least in a part of the surface pattern (11) a plurality of identical surface portions (15) with optically active structures (4) which differ from the surrounding mosaic structure are additionally arranged regularly in regions (28 through 33; 37; 38) which are independent of the mosaic, that center points (16) of the surface portions (15) in the regions (28 through 33; 37; 38) form a dot matrix with more than 5 dots per mm, that the surface portions (15) are of a largest dimension of less than 0.2 mm and have a length-to-width ratio of at least 3:1, that in each of the regions (28 through 33; 37; 38) the surface portions (15) in the dot matrix are oriented in parallel relationship with a preferred direction (34), and that the regions (28 through 33; 37; 38) form an item of concealed information which is determined by the preferred direction (34) and which is not perceptible to the naked eye but which is reproduced in a color copy of the surface pattern (11) identifiably to the naked eye by means of hatchings as an artefact.

2. A security element as set forth in claim 1 characterised in that a unit cell (40) of the dot matrix is of a rectangular or hexagonal shape.

3. A security element as set forth in claim 1 or claim 2 characterised in that the regions (28 through 33; 37; 38) are adjacent and that the adjacent regions (28 through 33; 37; 38) differ in the preferred direction (34) of the surface portions (15) predeterminedly by the concealed information.

4. A security element as set forth in claim 1 or claim 2 characterised in that the regions (28 through 33; 37; 38) are separated by free areas (35) having no surface portions (15), that the concealed information is determined by the arrangement of the free areas (35) and that the regions (28 through 33; 37; 38) have the same preferred direction (34) of the surface portions (15).

5. A security element as set forth in one of claims 1 through 4 characterised in that provided in the surface portions (15) are flat mirror surfaces (10) and in the surface elements (12; 13; 14) there are microscopically fine, light-scattering or diffracting structures.

6. A security element as set forth in one of claims 1 through 4 characterised in that provided in the surface portions (15) are microscopically fine, light-scattering or diffracting structures and in the surface elements (12; 13; 14) there are flat mirror surfaces (10).

7. A security element as set forth in one of claims 1 through 4 characterised in that the optically active relief structures (4) in the surface portions (15) and in the surface elements (12; 13; 14) are grating structures, wherein the grating structures of the surface portions (15) differ from the grating structures of the surface elements (12; 13; 14) at least in respect of the azimuth and/or the spatial frequency (f).

8. A security element as set forth in one of claims 5 through 7 characterised in that the microscopically fine, light-diffracting structures are linear grating structures.

9. A security element as set forth in one of claims 5 through 7 characterised in that the microscopically fine, light-diffracting structures are cross grating structures with predetermined spatial frequencies (f1; f2).

10. A security element as set forth in claim 5 or claim 7 characterised in that the grating structure is repeated in mutually abutting surface squares (42) with a side length of less than 100 micrometers and that the grating structure formed in each surface square (42) is a microscopically fine relief of concentrically arranged, circular grooves.

11. A security element as set forth in claim 10 characterised in that the grating structures are in the form of reflecting Fresnel lenses.

12. A security element as set forth in one of claims 8 through 10 characterised in that the spatial frequencies (f; f1, f2) of the grating structures are selected from the ranges of between 350 and 550 lines per millimeter and/or between 725 and 1025 lines per mm.

13. A security element as set forth in claim 5 or claim 6 characterised in that the microscopically fine structures scattering incident light beams (19) are matt structures.

14. A security element as set forth in one of claims 1 through 13 characterised in that one of the regions (28 through 33) performs the function of a background region (37) and the other regions (28 through 33) arranged within the background region (37) involve the function of character regions (38) and are in the shape of graphic or alphanumeric characters and that the preferred direction (34) of the surface portions (15) in the background region (37) and the preferred direction (34) of the surface portions (15) in the character regions (38) are oriented in mutually perpendicular relationship.

15. A security element as set forth in claim 14 characterised in that a plurality of background regions (37) are so arranged that the preferred directions (34) of the surface portions (15) in each background region (37) face radially away from a point.

16. A security element as set forth in one of claims 1 through 13 characterised in that the regions (28 through 33) perform the function of a background region (37) and that free areas (35) within the background region (37) involve the function of character regions (38) and are in the shape of graphic or alphanumeric characters.

17. A security element as set forth in one of claims 1 through 16 characterised in that the degree of surface coverage of the surface portions (15) in the regions (28 through 33; 37; 38) does not exceed 20%.
